(19) United States
(12) Patent Application Publication
(10) Pub. No.: US 2024/0129204 A1
(43) Pub. Date: Apr. 18, 2024

(54) GRAPHICAL USER INTERFACE FOR REPRESENTING TUNNELS AND STRETCHED NETWORKS IN A VIRTUAL ENTITY PATHWAY VISUALIZATION

(71) Applicant: VMWARE, INC, Palo Alto, CA (US)

(72) Inventors: Arnab Khound, Bangalore (IN); Vrushali Bayani, Pune (IN); Aolee Kriti, Bangalore (IN); Sanket Bindle, Sunnyvale, CA (US); Nitin Meena, San Francisco, CA (US); Ganesh Wagle, Pune (IN)

(21) Appl. No.: 18/099,983

(22) Filed: Jan. 23, 2023

(30) Foreign Application Priority Data
Oct. 12, 2022 (IN) 202241058231

(51) Int. Cl. H04L 41/22; H04L 47/2483

(52) U.S. Cl. CPC H04L 41/22; H04L 47/2483

(57) ABSTRACT

Systems and methods are described for providing a GUI for representing tunnels and stretched networks in a virtual entity pathway virtualization. In an example, an application can obtain data related to physical and virtual entities in a stretch network and build a model of the stretch network using the data. The model can be based on a flow of network traffic between two entities. The application can render a GUI that illustrates the flow of traffic between two entities, including any datacenters, physical entities, and virtual entities involved in the network flow. The GUI can display the entities in a way that shows which virtual extensible local area network is being used to transfer the network traffic at each step in the network flow. The GUI can also display icons representing remote tunnel endpoints that show how network traffic is transferred between datacenters.

### RELATED APPLICATION

Benefit is claimed under 35 U.S.C. 119(a)-(d) to Foreign Application Serial No. 202241058231 filed in India entitled “GRAPHICAL USER INTERFACE FOR REPRESENTING TUNNELS AND STRETCHED NETWORKS IN A VIRTUAL ENTITY PATHWAY VISUALIZATION”, on Oct. 12, 2022 by VMware, Inc., which is herein incorporated in its entirety by reference for all purposes.

### BACKGROUND

Modern datacenters include large numbers of physical and virtual entities. Virtual entities increase the complexities of monitoring, troubleshooting, searching characteristics of, and visualizing these dynamically configurable networks. Many networks today include multiple datacenters at different geographic locations that communicate with each other. Such networks, referred to herein at “stretch networks,” use particular types of virtual entities and protocols for inter-location communication, such as virtual extensible local area networks (“VXLANs”) and remote tunnel endpoints (“RTEPs”). Stretch networks further increase the complexities described above.

Existing systems may only monitor and collect data within a single datacenter. Existing systems also may not be able to understand these new architectures, entities, and the relationships between entities communicating with each other from different datacenters. Also, existing systems are unable to visually illustrate network paths that include VXLANs and RTEPs. For example, existing systems are unable to adequately illustrate network traffic through VXLANs that are not configured at each datacenter in the stretch network. Therefore, present systems may not effectively monitor or visualize the physical and virtual entity configurations within modern stretch networks, and they do not provide adequate capabilities to search characteristics of such networks.

As a result, a need exists for an interface that visualizes network traffic with tunnels and VXLANs in stretched networks.

### SUMMARY

Examples described herein include systems and methods for providing a graphical user interface (“GUI”) for representing tunnels and stretched networks in a virtual entity pathway virtualization. In an example, an application can model a stretch network that has physical and virtual entities. Physical entities can be any physical devices used for processing, storing, and/or exchanging data. Virtual entities can be any entities virtualized in software. The physical and virtual entities in the stretch network can be deployed at various datacenters at different locations.

Modeling the stretch network can include multiple substages. For example, in a first substage, the application can obtain data relating to entities (hereinafter referred to as “entity data”). Entity data can include any data related to entities in the stretch network, such as states data, static and dynamic relationships data, statistics, events data, performance data, and configuration data. Configuration data can include any information associated with the configuration of any entity or combination of entities in a datacenter. Some examples of configuration data can include a number of central processing units (“CPUs”) assigned to a virtual machine (“VM”), network and communication paths in a VXLAN, rules in a physical or virtual firewall, network interface cards (“NICs”) connected to a VM, changes in system configurations, and so on.

At a second substage, the application can categorize the entities by entity type. Some examples of types of physical entities can include application servers, storage servers, load balancers, NICs, firewalls, switches, routers, client devices, and so on. Some examples of virtual entity types can include VMs, virtual firewalls, virtual switches, virtual routers, virtual local area networks, VXLANs, and so on.

At a third substage, the application can assign entities to predefined network diagram levels. In one example, the network diagram levels can correspond to the entity types. For example, VMs can be assigned to one diagram level, physical servers can be assigned to another diagram level, and so on. Each datacenter can have its own set of network diagram levels, and entities can be assigned to levels corresponding to the datacenter in which they are deployed.

In a fourth substage, the application can associate entities with each other based on relationships. For example, the application can associate virtual entities with the physical devices on which they run. Entities can also be associated with each other based on how network traffic passes between them. For example, a stretch network can utilize RTEPs to secure network traffic passing from one datacenter to another over a public network. Datacenters can be associated with each other using network traffic that passes between their corresponding RTEPs. Alternatively, or in addition, the datacenters can be associated by a VXLAN level based on shared VXLANs configured at the datacenters. In a similar manner, entities within a datacenter that communicate with each other can also be associated with each other based on network flows and/or VXLANs.

The model can comprise the network level assignments and entity associations.

In an example, the application can identify a network flow between two virtual entities, such as two VMs. A network flow can be the route a packet would travel from one virtual entity to another. The terms “packet pathway” and “network flow” are referred to interchangeably herein. In one example, the network flow can be provided by a user in a graphical user interface (“GUI”). For example, the GUI can allow a user to select a VM to view network flows that include the selected VM. Alternatively, the user can select two VMs to view network flows between them. In one example, the application can link entities in the model based on the network flows. For example, if network traffic in the network flow passes from one entity to another, then the application can link those entities accordingly.

The application can render, in the GUI, an arrangement of active icons corresponding to the physical and virtual entities. The application can also render the network flow from a source entity to a destination entity. The rendered network flow can indicate each physical and virtual entity, as well as each datacenter, that the network traffic passes through to reach the destination entity. The GUI can include VXLAN bars that are displayed over datacenters and servers that are configured with the corresponding VXLAN. Icons (or nodes) for entities configured on a specific VLXAN can be displayed overlaying the corresponding VXLAN bar. This can allow the user to view the network flow in a VXLAN context, which may indicate to the user why, for example, network traffic in the network flow passes through multiple datacenters to reach the destination entity. For example, if the datacenter of the source entity and the datacenter of the destination entity are not configured with any like VLXANs, then network traffic may be routed through other datacenters so that the network traffic can be moved to a VXLAN configured at the destination datacenter. This can allow the user to view network inefficiencies and reconfigure network settings to eliminate unneeded steps. For example, in the example described above, the user can add a VLXAN to the source or destination datacenter so that intermediary datacenters can be eliminated from the network flow.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is a flowchart of an example method for providing a GUI for representing tunnels and stretched networks in a virtual entity pathway virtualization.

FIG. 2 is a sequence diagram of an example method for providing a GUI for representing tunnels and stretched networks in a virtual entity pathway virtualization.

FIG. 3 is an illustration of an example GUI for representing tunnels and stretched networks in a virtual entity pathway virtualization.

FIG. 4 is a block diagram of an example datacenter management system.

FIG. 5 is an illustration of an example system for providing the GUI described herein.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Systems and methods are described for providing a GUI for representing tunnels and stretched networks in a virtual entity pathway virtualization. In an example, an application can obtain data related to physical and virtual entities in a stretch network and build a model of the stretch network using the data. The model can be based on a flow of network traffic between two entities. The application can render a GUI that illustrates the flow of traffic between two entities, including any datacenters, physical entities, and virtual entities involved in the network flow. The GUI can display the entities in a way that shows which virtual extensible local area network is being used to transfer the network traffic at each step in the network flow. The GUI can also display icons representing remote tunnel endpoints that show how network traffic is transferred between datacenters

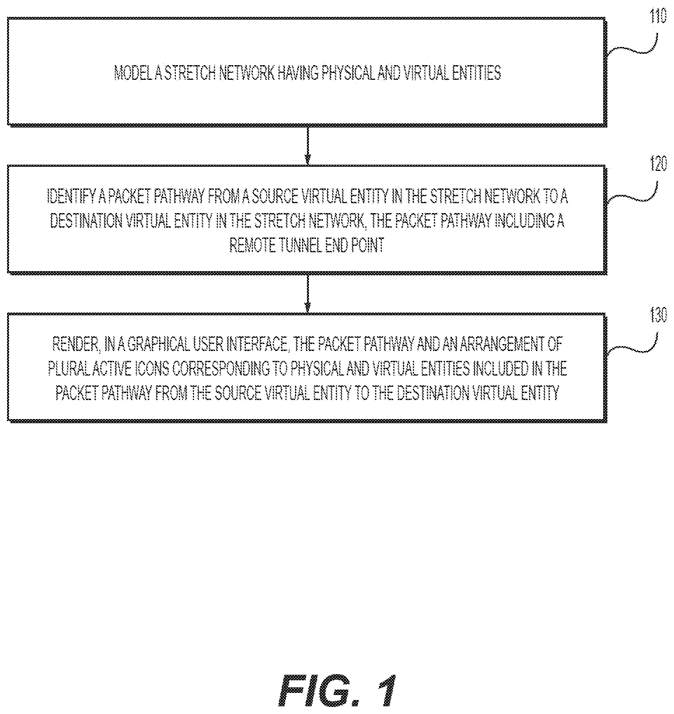

FIG. 1 is a flowchart of an example method for providing a GUI for representing tunnels and stretched networks in a virtual entity pathway virtualization. At stage 110, an application can model a stretch network having physical and virtual entities. Modeling the stretch network can include various substages. For example, at a first substage, the application can obtain data relating to entities in the network (hereinafter referred to as “entity data”). The entities can be physical or virtual entities of the stretch network. Physical entities can be any physical devices used for processing, storing, and/or exchanging data. Virtual entities can be any entities virtualized in software. The entity data can be in any appropriate format, such as a network topology. In one example, the application can identify entities to include in the GUI and retrieve entity data specific to those entities. For example, the GUI can allow a user to designate a portion of the network to render, such as by selecting one or more VMs, datacenters, or applications. The application can identify other entities that the selected entity interacts with and any intermediary entities. As an example, if a user selects an application, then the application can identify a VM that hosts the application, a physical server that the host VM runs on, any other VMs that the host VM communicates with, and any network entities involved in data transfers between host VM and other VMs. The application can query the database for entity data of the identified entities.

In an example, the entity data can be retained at a storage component within the computing network, such as a database server. The application can retrieve the appropriate entity data from such a storage component. As an example, if the entity data is stored on a database server, then the application can send a database query to the database server requesting the entity data, and the database server can respond with a data file that includes the requested entity data.

At a second substage, the application can associate each entity with a corresponding entity type. Some examples of types of physical entities can include application servers, storage servers, load balancers, NICs, firewalls, switches, routers, client devices, and so on. Some examples of virtual entity types can include VMs, virtual firewalls, virtual switches, virtual routers, virtual local area networks, VXLANs, and so on.

At a third substage, the application can assign entities to predefined network diagram levels. In one example, entities assigned to a network diagram level can be of the same or similar entity type. For example, one network diagram level can include servers, another can include VMs, another can include VXLANs, and so on. In another example, the levels can have a hierarchal structure. For example, for a GUI that renders packet pathways between VMs, the VMs can be assigned to a first or top level. Subsequent entities can be assigned subsequent levels according to general network interconnection conventions to indicate increasingly remote physical or logical connectedness. As an example, virtual distributed routers and edge routers or gateways can be assigned to a second level. Distributed virtual port groups (“DVPGs”) and VXLANs can be assigned to a third level, and so on.

For stretch networks, the application can group the entities, and their corresponding hierarchies, by geographic location. For example, each location can have its own set of network diagram levels, and the application can assign entities to the appropriate network diagram levels at their corresponding location. In another words, the application treats each location as its own computer network with its own entity assignments. For example, if a stretch network has datacenters in London and Paris, then the application can assign entities to a corresponding level that is specific to the city in which the entity is located. As an example, a VM running on a server in London can be assigned to a VM level for London, and a VM running on a server in Paris can be assigned to a VM level for Paris.

The application can then link the location hierarchies to each other through RTEPs, which are network entities used in inter-location communication. For example, VMs at different locations can communicate with each other when they are on the same virtual local area network (“VLAN”) or VXLAN. RTEPs encapsulate overlay traffic between datacenters at different locations. As an example, when a VM at a first location sends a data communication to a VM at a second location, an RTEP at the first location receives the data communication, encapsulates it using a tunnelling protocol, and sends the data communication over the Internet to an RTEP at the second location. The RTEP at the second location receives the data communication, de-encapsulates it, and sends the data communication to the VM at the second location. RTEPs can be configured on edge devices and clusters at each location.

In a fourth substage, the application can associate entities with each other based on relationships. For example, the application can associate virtual entities with the physical devices on which they run. Entities can also be associated with each other based on how network traffic passes between them. The model can therefore be based on network flows. For example, a stretch network can utilize RTEPs to secure network traffic passing from one datacenter to another over a public network. Datacenters can be associated with each other using network traffic that passes between their corresponding RTEPs. Alternatively, or in addition, the datacenters can be associated by a VXLAN level based on shared VXLANs configured at the datacenters. In a similar manner, entities within a datacenter that communicate with each other can also be associated with each other based on network flows and/or VXLANs.

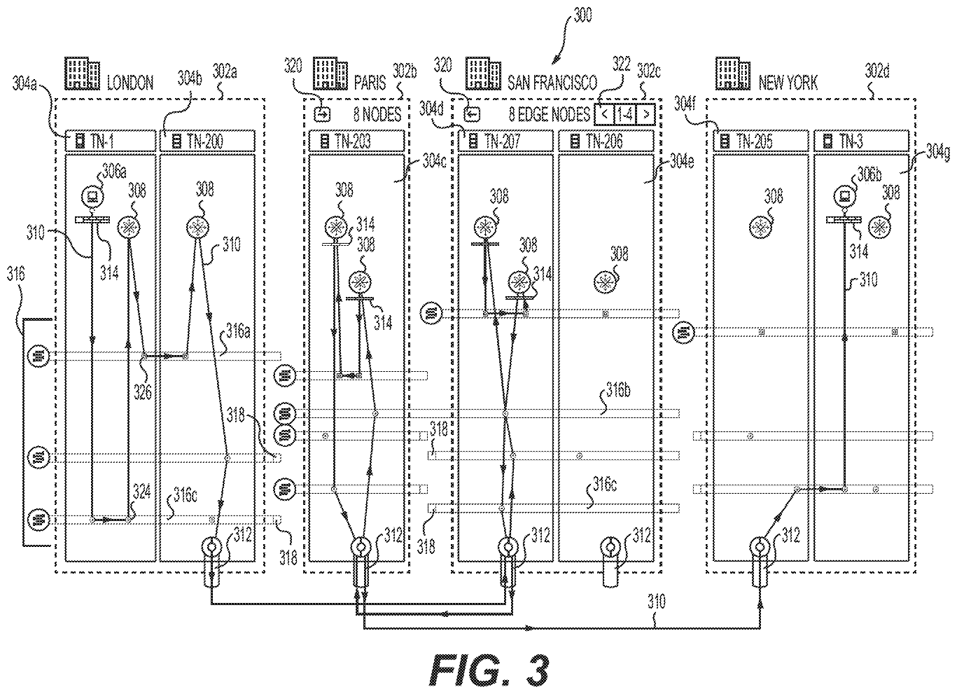

In an example, each network diagram level can correspond to a different layer in the GUI. The application can be configured to render layers in an ordered manner near layers of neighboring hierarchal levels. In another words, entities of different types that are connected together are rendered closer together in the GUI. For stretch networks, the application can render the entity hierarchies by location. An example of such a GUI is illustrated in FIG. 3 and described later herein.

At stage 120, the application can identify a network flow between two entities. A network flow can be the route a packet would travel from one virtual entity to another. In one example, network flows can be included in the entity data retrieved previously. For example, if the entity data is in the form of a network topology, the network topology can indicate how data flows between each entity. For example, the entity data can indicate that a first VM at a first location communicates with a second VM at a second location, which intermediary entities facilitate the communication, and in which direction(s) the communication flows.

In an example, the network flows can be associated with a virtual entity selected by a user in a GUI, such as two VMs. For example, the GUI can allow a user to select a VM to view network flows that include the selected VM. Alternatively, the user can select two VMs to view network flows between them. In one example, the application can link entities in the model based on the network flows. For example, if network traffic in the network flow passes from one entity to another, then the application can link those entities accordingly. In one example, the model can be comprised of one or more data tables with information about the entities. The application can link entities using one or more fields for an entity in the data table that indicate where network traffic is received from and where network traffic is sent to in the network flow.

At stage 130, the application can render, in the GUI, the network flow and an arrangement of active icons corresponding to the physical and virtual entities included in the network flow from a source virtual entity to a destination virtual entity. The format can depend on the structure of the portion of the network being rendered. The GUI 300 illustrated in FIG. 3 is an example of a GUI formatted for a stretch network. Turning now to FIG. 3, the GUI 300 separates the various virtual entities based first on their location, and second on a physical server or server cluster that the virtual entities are running on. For example, the GUI 300 includes a location pane 302a for a datacenter in London, a location pane 302b for a datacenter in Paris, a location pane 302c for a datacenter in San Francisco, and a location pane 302d for a datacenter in New York. Location panes, such as location panes, 302a, 302b, 302c, and 302d, are referred to collectively as “location panes 302.”

The location panes 302 can represent a first layer of the GUI 300. A second layer can include physical servers or clusters. The servers can be displayed as nodes that are large enough for nodes of other entities to be displayed overtop, such as a large rectangle or other geometric shape. The server nodes can be displayed within a pane corresponding to the datacenter where they are located. For example, in the GUI 300, server nodes 304a and 304b are displayed within the location pane 302a for London, server node 304c is displayed within the location pane 302b for Paris, server nodes 304d and 304e are displayed within the location pane 302c for San Francisco, and server nodes 304f and 304g are displayed within the location pane 302d for New York. Server nodes, such as server nodes 304a, 304b, 304c, 304d, 304e, 304f, and 304g, are referred to collectively as “server nodes 304.” The server nodes 340 in the GUI 300 include a box with the name of the server (e.g., the name for the server node 304a is “TN-1”) and a box representing the server itself below the name. Components running on a server or are part of a server, both physical and virtual, are displayed within their corresponding server node 304.

To save space, the location panes 302 can be collapsible. For example, when a datacenter includes more servers than what is being displayed, the GUI can display an expansion button 320. The expansion button 320 can be any selection mechanism that allows a user to expand a location pane 302 to display additional server nodes 304. For example, the location pane 302b for Paris is displayed with only the server node 304c, but, as indicated next to the expansion button 320, there are eight server nodes 304 at the Paris location. A user can select the expansion button 320 to display additional server nodes 304. In an example, the GUI can be configured to display a maximum number of server nodes 304 simultaneously within a location pane 302. As an example, the location pane 302c for San Francisco is expanded to show two of eight server nodes 304 for the location. A user can view additional server nodes 304 for the San Francisco location using a scrolling tool 322 to scroll through the other server nodes 304. Additionally, the user can select the expansion button 320 within the location pane 302c to collapse the location pane 302c so that it only shows one server node 304.

Within the server nodes 304, the GUI can display layers with entities related to the corresponding server. For example, the GUI 300 includes a layer for VMs, represented by the VM nodes 306a and 306b. Additionally, virtual distributed router nodes 308 represent virtual distributed routers, virtual firewall nodes 314 represent virtual firewalls, virtual port nodes 324 represent virtual ports, TEP nodes 326 represent TEPs, and RTEP nodes 312 represent RTEPs.

The GUI 300 includes a layer with VXLAN bars 316. The VXLAN bars 316 are horizontal bars representing VXLANs, such as VLXAN bars 316a, 316b, and 316c. VXLAN bars 316 can span location panes 302 and server nodes 304 corresponding to the locations and servers that the corresponding VXLANs are configured on. For example, the VLXAN bar 316a spans the server nodes 304a and 306b of the location pane 302a for London. This indicates that the VXLAN corresponding to VLXAN bar 316a is only configured on the server nodes 304a and 306b. The VLXAN bars can span multiple locations. For example, the VLXAN bar 316b spans the server node 304c at the location pane 302b for the Paris location and the server nodes 304d and 304e of the location pane 302c for the San Francisco location. This indicates that the corresponding VLXAN is configured at both the Paris and San Francisco locations. The VXLAN bar 316 can include breaks across server nodes 304 or location panes 302 for locations that are not configured with the corresponding VLXAN. The breaks can be delineated by a special format or icon. For example, the VLXAN bar 316c spans the server nodes 304a and 306b of the location pane 302a for London and the server nodes 304d and 304e of the location pane 302c for the San Francisco location. However, the VLXAN bar 316c does not span the location pane 302b for the Paris location. Instead, the VLXAN bar 316c includes delineating breakers 318 on either side of the location pane 302b, thereby indicating that the VLXAN corresponding to VLXAN bar 316c is not configured at the Paris location.

The GUI 300 illustrates a packet pathway between VMs corresponding to VM nodes 306a and 306b. This packet pathway is illustrated by the edge 310. The arrows on the edge 310 indicate the direction of traffic for network traffic traveling from the VM corresponding to the VM node 306a (referred to hereinafter as “VM1”) to the VM corresponding to the VM node 306b (referred to hereinafter as “VM2”). The packet pathway represented by edge 310 illustrates various types of network traffic exchanges.

For example, the GUI 300 illustrates changing VXLANs using a virtual distributed router. The virtual port nodes 324 (illustrated by circles with a center dot) are positioned overlaying the VXLAN bars 316 for the VXLANs they correspond to. As shown in the GUI 300, the edge 310 begins at the VM node 306a and goes to a virtual port node 324 on the VXLAN bar 316c. The edge 310 then proceeds to another virtual port node 324 on the VXLAN bar 316c and then up to a virtual distributed router node 308 located within the server node 304a. This sequence indicates that the VM1 sends the network traffic to a virtual distributed router on the same server. The VM1 sends the traffic through a virtual port for the VM1 to a virtual port for a virtual distributed router, and both virtual ports are configured with the VXLAN corresponding to the VXLAN bar 316c. The edge 310 then continues to a TEP node 326 on the VXLAN bar 316a, indicating that the network traffic is moved from the VXLAN of the VXLAN bar 316c to the VLXAN of the VXLAN bar 316a.

The GUI 300 also illustrates network traffic traveling between physical servers in a datacenter. For example, the GUI 300 shows the edge 310 traveling from a TEP edge node 326 at the server node 304a to a TEP edge node 326 at the server node 304b. TEPs encapsulate overlay traffic between servers at the same location. The GUI 300 illustrates the server of server node 304a transferring the network traffic to the server of server node 304b using a TEP protocol. As shown in the GUI 300, the server of server node 304b passes the network traffic through a virtual distributed router to move the network traffic onto the VXLAN of the VXLAN bar 316b.

The GUI 300 also illustrates network traffic traveling between locations. For example, from the server node 304b the edge 310 proceeds through an RTEP node 312 at the server node 304b and through an RTEP node 312 of the server node 304d at the location pane 302c of the San Francisco location. This can indicate that an RTEP edge device at the server of server 304b sends the network traffic to an RTEP edge device at the server of the server 304d. As shown in the GUI 300, the network traffic passes through the RTEP edge devices to and from virtual ports on the same VLXAN.

The layered configuration of the GUI 300 allows a complex packet pathway to be illustrated in a clear and user-friendly format, particularly in stretch networks that utilize VXLANs. For example, the GUI 300 demonstrates why the packet pathway illustrated by edge 310 must pass through servers at two different data centers before arriving at the intended destination. The location pane 302a (source destination) does not share any VLXANs with the location pane 302d (target destination). Although the location pane 302b shares a VLXAN with the location pane 302d, the delineating breakers 318 allow the user to see that the location pane 302a does not share any VXLANs with the location pane 302b. However, the GUI 300 shows that the location panes 302b and 302c share one VXLAN, and the delineating breakers 318 allow the user to see that the location panes 302a and 302c share a VXLAN. As a result, in order to transfer data traffic from the London datacenter (location pane 302a) to the New York location (location pane 302d), the traffic must be first transferred to the San Francisco location (location pane 302c on one VXLAN, moved to a different VXLAN, sent to the Paris location (location pane 302b), moved again to a different VXLAN, and then sent to the New York location (location pane 302d). The user can also view every network entity involved in the packet pathway.

The format of the GUI 300 can allow a user to view inefficiencies in a network and make appropriate changes. For example, the packet pathway illustrated by the edge 310 could be simplified by configuring the New York datacenter with the VXLAN of VXLAN bar 316a. By doing this, network traffic traveling from the VM1 to the VM2 could be sent directly from the London datacenter to the New York datacenter instead of passing through the datacenters in Paris and San Francisco.

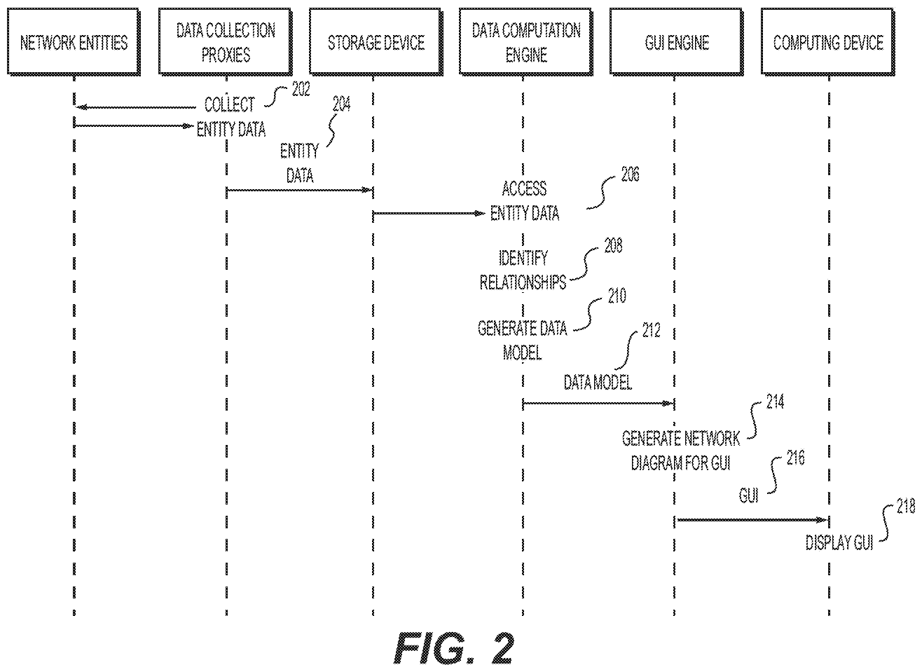

FIG. 2 is a sequence diagram of an example method for providing a GUI for representing tunnels and stretched networks in a virtual entity pathway virtualization. At stage 202, data collection proxies can collect entity data from network entities. The entity data can include states data, static and dynamic relationships data, statistics, events data, performance data and configuration data associated with the entities. Performance data can relate to the performance of any entity or combination of entities in the network. Some examples can include CPU utilization, packet processing, packet transmission and reception drops, memory utilization, and so on. Configuration data can include any information associated with the configuration of any entity or combination of entities in a datacenter. Examples of configuration data can include a number of CPUs assigned to a VM, network and communication paths in a VXLAN, rules in a physical or virtual firewall, NICs connected to a VM, changes in system configurations, and so on. These are just a few examples of almost limitless types of performance and configuration data. At stage 204, the data collection proxies can send the performance data to a storage device. The storage device can be any device with the network that has data storage capabilities, such as a database server or cluster.

At stage 206, a data computation engine can access the entity data. In one example, the data computation can have read access to read the data stored on the storage device. Alternatively, the computation engine can request portions of the entity data from the storage device, such as by making a database query. The entity data can be stored as one or more computer-readable files within the storage device.

At stage 208, the data computation engine can identify relationships. The relationships can correspond to now entities in the network relate to and communicate with each other. For example, the data computation engine can identify which VMs are installed on a server, which VXLANs an entity is configured with, what other VMs a VM communicates with, and so on. Identifying relationships can also include identifying packet pathways that indicate how network traffic moves from one entity to another. For example, the data computation engine can identify the datacenter locations, firewalls, virtual distributed ports, VXLANs, servers, virtual ports, TEPs, and RTEPs are involved in sending network traffic from one VM to another.

At stage 210, the data computation engine can generate a data model of the network. The data models can represent physical, virtual, and logical entities and entity relationships for different periodic and aperiodic events in a network. For example, this can include CPU and memory utilization, logical and physical connections, end-to-end communication paths, logical layer 2 and layer 3 network connections, application topologies, VXLAN topologies, port groups, and so on.

At stage 212, the data computation engine can provide the data model to a GUI engine. In one example, the computation engine and GUI engine can be hosted on different servers, and the data computation engine can send the data model to the GUI engine as a data file. The data computation engine can send such a data file using any appropriate communication protocol, such as an Application Programming Interface (“API”) call.

At stage 214, the GUI engine can generate a network diagram for a GUI. This can be a data file that can be used to display a visualization of the network topology in a GUI, such as the GUI 300 described previously herein. In one example, the GUI engine can generate the network diagram as a hypertext markup language (“HTML”) file. For example, the GUI can be part of a web-based application that a user can access through a web browser. In such an example, the GUI can be sent to the user's device as an HTML file to be rendered within the web browser.

The GUI can include elements for displaying inter-location communications between data centers in a stretch network. For example, the GUI can include nodes for RTEPs at each location and edges that pass through the RTEPs indicating a direction of network traffic passing through the RTEP. The GUI can also include bars representing VXLANs, and the bars can overlay servers and locations configured with the VXLAN. The position of some entities can be based on their configuration settings. For example, virtual ports can be displayed overlaying bars for VXLANs that they are configured for. The GUI can also include one or more edges representing packet pathways, or paths that network traffic take from a source entity to a destination entity. The GUI 300 illustrated in FIG. 3 is an example of such a GUI.

At stage 216, the GUI engine can send the GUI to a computing device. The computing device can be any device that a user can use to access the GUI. As some examples, the computing device can be a server, personal computer, tablet, or cell phone. The GUI engine can send the GUI using any appropriate communication protocol. For example, if the GUI is accessed through a web browser, then the GUI engine can send the GUI using a hypertext transfer protocol secure (“HTTPS”) protocol. Alternatively, if the GUI is part of an application installed on the computing device, then the GUI engine can send data for the GUI using an API call.

At stage 218, the computing device can display the GUI. For example, the computing device can process the data file and render the GUI in a display component of the computing device.

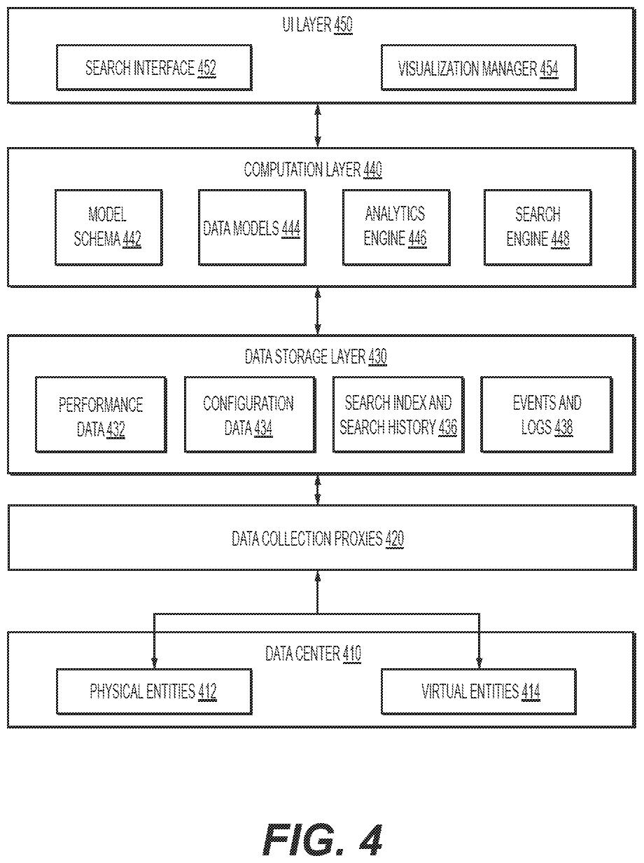

FIG. 4 is a block diagram of an example datacenter management system for providing the GUI described herein. The datacenter management system can include a datacenter 410 with various physical entities 412 and virtual entities 414. Physical entities 412 can be any physical devices used for processing, storing, and/or exchanging data. A few examples of physical entities 412 include application servers, storage servers, load balancers, NICs, firewalls, switches, routers, client devices, and so on. The virtual entities 414 can include any entities virtualized in software, such as VMs, virtual firewalls, virtual switches, virtual routers, VLANs, VXLANs, and so on. The datacenter 410 also can include different logical entity relationships, such as layer 2 and layer 3 logical networks. These are just examples of an almost limitless number of different physical and virtual entities and relationships that can exist within the datacenter 410.

The datacenter management system can use time-series-based modeling of entities and properties (“Objects”) to effectively capture the evolving state of a datacenter. Models represent physical, virtual, and logical entities and entity relationships for different periodic and aperiodic events. The datacenter management system can capture different states data, static and dynamic relationships data, statistics, events data, performance data and configuration data associated with the entities. The performance data measures performance of different entities, such as CPU utilization, memory utilization, packet drops, and so on. The configuration data identifies configurations within entities, such as the number of CPUs assigned to a virtual machine, the rules used by a physical or virtual firewall, or the implied set of virtual machines affected by a virtual or physical firewall rule.

Data collection proxies 420 (referred to interchangeably as just “proxies 420”) are alternatively referred to as crawlers and collect and store data from physical entities 412 and virtual entities 414 in a data storage layer 430. The data can include performance data 432, configuration or change data 434, and event and log data 438, such as alerts, problems, faults, and so on. The datacenter management system also can store search indexes and search histories 436 from search queries.

Performance data 412 can be associated with the performance of any entity or combination of entities in the datacenter 410. Examples of performance data 432 can include CPU utilization, packet processing, packet transmission and reception drops, memory utilization, and so on. Configuration data 434 can include any information associated with the configuration of any entity or combination of entities in the datacenter 410. Examples of configuration data 434 can include a number of CPUs assigned to a VM, network and communication paths in a VXLAN, rules in a physical or virtual firewall, NICs connected to a VM, changes in system configurations, and so on. These are just a few examples of almost limitless types of performance and configuration data.

Data collection proxies 420 can periodically collect performance data 432 and/or configuration data 434. For example, proxies 420 can monitor CPU utilization for a VM every ten minutes and save the utilization values as part of performance data 432. Data collection proxies 420 can periodically collect other performance data 432 and/or configuration data 434. For example, collection proxies 420 can identify the number of CPUs assigned to a VM as part of configuration data 434.

Data collection proxies 420 can include any combination of existing and customized programs for monitoring and extracting data from the entities 412 and 414. For example, physical entities 412, such as routers and switches, can include application programming interfaces (“APIs”) for extracting CPU utilization, memory utilization, packet drops, routing tables, logged data, address resolution protocol (“ARP”) tables, and so on.

A computation layer 440 can use the data in storage layer 430 to provide information to a user interface (“UI”) layer 450. A model schema 442 can identify the general relationships and properties associated with entities in datacenter 410. Data models 444 represent the particular performance data 432 and configuration data 434 associated with the entities in datacenter 410. For example, this can include CPU and memory utilization, logical and physical connections, end-to-end communication paths, logical layer 2 and layer 3 network connections, application topologies, VXLAN topologies, port groups, and so on. Some data models 444 can be created manually and other data models 444 can be dynamically generated.

An analytics engine 446 can automatically monitor and identify data and other events. The analytics engine 446 can include event detectors that identify significant events in the datacenter 410. For example, the event detector can identify configuration changes and performance data representing the performance status of datacenter 410. The analytics engine 446 can also operate as outlier detector that identifies events that are outside normal operating levels. For example, an outlier detector can identify CPU utilization above a particular threshold level. The analytics engine 446 can also operate as a problem detector that identifies problems in datacenter 410. For example, the problem detector can identify large packet losses or configuration mismatches between entities.

A search engine 448 can conduct natural language searches within the datacenter 410 and identify a search query intent based on model schema 442 and a datacenter dictionary. Instead of operating just on keywords, the search engine 448 can also understand search query phrases that can be part natural language and part expression. This provides richer intent expression, greater ease of use, and applies well to the datacenter problem domain. For example, a search term such as TROUBLESHOOT can cause the search engine 448 to search problem data generated by the analytics engine 446.

The search engine 448 can operate as a time machine executing queries for specified time intervals. For example, a user can enter a search term requesting the search engine 448 to show all configuration changes for a specified network over the past two days. In another example, the user can enter a search term requesting CPU usage for a host device over the last two days. The data models 444 can be configured in a unique time series format that enables search engine 448 to quickly identify events for any selectable time period.

The data models 444 can include identifiers associated with different physical and virtual entities, networks, performance data, and/or configuration data. The search engine 448 can search for data or provide search suggestions based on the data models 444. For example, one of the data models 444 for a virtual firewall can contain firewall rules. A user can enter the search term RULES. The search engine 448 can identify the firewall rules in the model or provide a suggestion for displaying the rules identified in the virtual firewall model.

The user interface layer 450 can include a search interface 452 for receiving search queries and displaying search results. Search interface 452 can receive natural language-based expressions for the search engine 448 and display the results from the search engine 448 in a textual and/or graphical format. A visualization manager 454 can generate topology diagrams representing different entities and network configurations within the datacenter. The search engine 448 and the search interface 452 can together function as a search system that provides interpretation of computer network status search queries that are entered by users and performs corresponding searches relating to the datacenter 410.

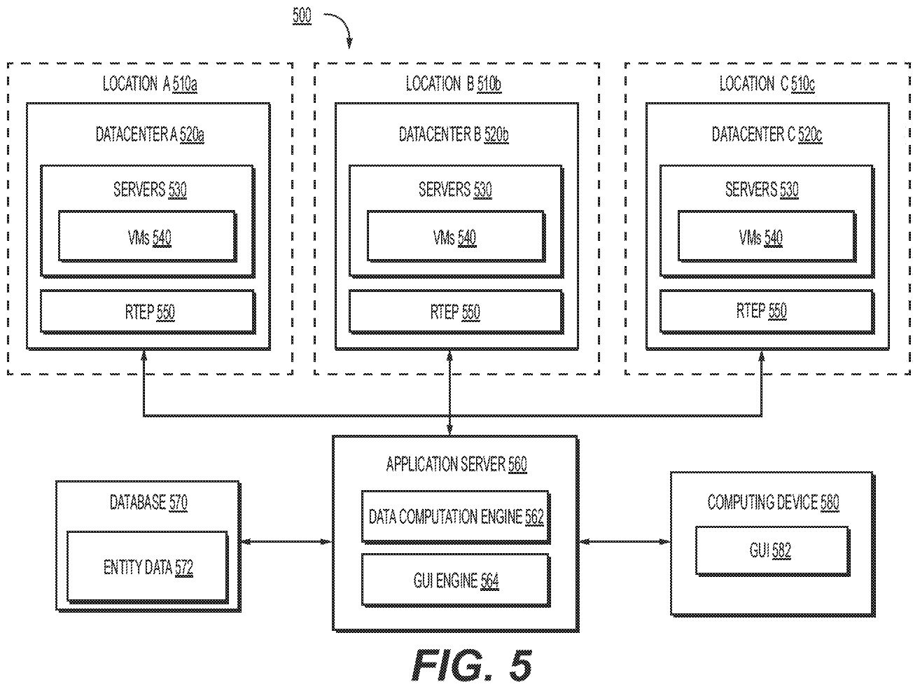

FIG. 5 is an illustration of an example system for providing the GUI described herein. A stretch network 500 can include datacenters at multiple locations. For example, the stretch network 500 includes a datacenter A 520a at location A 510a, a datacenter B 520b at location B 510b, and a datacenter C 520c at location C 510c. Each of the datacenters A 520a, B 520b, and C 520c (collectively referred to hereinafter as the “datacenters 520”) can include servers 530. The servers 530 can be one or more physical devices with computing capability to execute computer code, such as by executing a software program or hosting a virtual entity. The servers 530 can host VMs 540. The VMs 540 can be virtualized software, such as a virtual server or operating system.

Each datacenter 520 can include an RTEP 550. An RTEP 550 can be an edge device, or software running on an edge device, that encapsulates overlay traffic sent to other datacenters over a non-private network. The RTEPs 550 can also de-encapsulate network traffic received from other RTEPs. Each datacenter 520 can include additional network entities, both physical and virtual, that are not shown, such as load balancers, NICs, firewalls, switches, routers, client devices, virtual firewalls, virtual switches, virtual routers, VLANs, VXLANs, and so on.

The stretch network 500 can include an application server 560 that is responsible for providing a GUI 582 for representing tunnels and stretched networks in a virtual entity pathway virtualization. The application server 560 can be physical or virtual, and can be part of one or more of the datacenters 520. The application server 560 can include a data computation engine 562 that processes entity data 572 to identify relationships between network entities and generate a model of the stretch network 510. The entity data 572 can include any data related to network entities in the stretch network 500, including the servers 530, VMs 540, and RTEPs 550. Some examples of entity data can include states data, static and dynamic relationships data, statistics, events data, performance data and configuration data associated with the entities. In one example, the entity data can be collected by collection proxies (not shown) and stored in a database 570. The database 570 can be any type of storage component within the stretch network 500, such as a database server. The data computation engine 562 can retrieve or access the entity data 572 using any appropriate communication protocol, such as a database query.

A GUI engine 564 can use the model created by the data processing engine 562 to generate a diagram of the network for displaying in the GUI 582. A user can access the GUI 582 at a computing device 580. The computing device 580 can be any device that a user can use to access the GUI 582. As some examples, the computing device 580 can be a server, personal computer, tablet, or cell phone.

The GUI 582 can be a front-end interface of an application that a user can interact with to view and manage virtual entity pathway virtualization of the stretched network 500. The computing device 580 can communicate with the application server 560 using any appropriate communication protocol for exchanging data related to the GUI 582. For example, the application server 560 can be a web server, and the user can access the GUI 582 through a web browser. In such an example, the computing device 580 and application server 560 can communicating using HTTPS calls. Alternatively, the application as a whole, the GUI 582, or other components of the application may be installed directly on the computing device 580. In such an example, the computing device 580 and application server 560 can communicate using API calls.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather, any feature of any example described here can be incorporated into any other suitable example. It is intended that the specification and examples be considered as exemplary only, with a true scope and spirit of the disclosure being indicated by the following claims.

What is claimed is:

1. A non-transitory, computer-readable medium containing instructions that, when executed by a hardware-based processor, causes the processor to perform stages for providing a GUI for representing tunnels and stretched networks in a virtual entity pathway virtualization, the stages comprising:
constructing a model of a stretch network having physical and virtual entities and including at least a first datacenter and a second datacenter;
identifying a network flow from a source virtual entity in the stretch network to a destination virtual entity in the stretch network; and
generating a GUI window that includes a graphical representation of the network flow and an arrangement of active icons corresponding to physical and virtual entities included in the network flow from the source virtual entity to the destination virtual entity, wherein the GUI window visually indicates a direction of the network flow from the source virtual entity to the destination virtual entity, including an indication of the network flow passing from a first remote tunnel endpoint (“RTEP”) of the first datacenter to a second RTEP of the second datacenter.

2. The non-transitory, computer-readable medium of claim 1, wherein constructing the model comprises:
obtaining entity data relating to the physical and virtual entities;
categorizing, based on the entity data, the physical and virtual entities by entity type;
assigning the physical and virtual entities to network diagram levels according to their entity type; and
associating the physical and virtual entities based on relationships indicated in the entity data.

3. The non-transitory, computer-readable medium of claim 2, wherein associating the physical and virtual entities includes linking physical and virtual entities that communicate with each other in the network flow using a field in a data table.

4. The non-transitory, computer-readable medium of claim 1, wherein the GUI window visually indicates a virtual extensible local area network of at least a portion of the network flow.

5. The non-transitory, computer-readable medium of claim 4, wherein the virtual extensible local area network is visually indicated by a horizontal bar overlaying only nodes corresponding to datacenter locations that are configured with the virtual extensible local area network.

6. The non-transitory, computer-readable medium of claim 1, wherein the network flow is based on at least one virtual entity selected in the GUI by a user.

7. The non-transitory, computer-readable medium of claim 1, wherein the icons corresponding to physical and virtual entities included in the network flow are displayed in portions of the GUI window corresponding to a datacenter location at which the corresponding physical and virtual entities are deployed.

8. A system for providing a GUI for representing tunnels and stretched networks in a virtual entity pathway virtualization, comprising:
a memory storage including a non-transitory, computer-readable medium comprising instructions; and
a hardware-based processor that executes the instructions to carry out stages comprising:
constructing a model of a stretch network having physical and virtual entities and including at least a first datacenter and a second datacenter;
identifying a network flow from a source virtual entity in the stretch network to a destination virtual entity in the stretch network; and
generating a GUI window that includes a graphical representation of the network flow and an arrangement of active icons corresponding to physical and virtual entities included in the network flow from the source virtual entity to the destination virtual entity, wherein the GUI window visually indicates a direction of the network flow from the source virtual entity to the destination virtual entity, including an indication of the network flow passing from a first remote tunnel endpoint (“RTEP”) of the first datacenter to a second RTEP of the second datacenter.

9. The system of claim 8, wherein constructing the model comprises:
obtaining entity data relating to the physical and virtual entities;
categorizing, based on the entity data, the physical and virtual entities by entity type;
assigning the physical and virtual entities to network diagram levels according to their entity type; and
associating the physical and virtual entities based on relationships indicated in the entity data.

10. The system of claim 9, wherein associating the physical and virtual entities includes linking physical and virtual entities that communicate with each other in the network flow using a field in a data table.

11. The system of claim 8, wherein the GUI window visually indicates a virtual extensible local area network of at least a portion of the network flow.

12. The system of claim 11, wherein the virtual extensible local area network is visually indicated by a horizontal bar overlaying only nodes corresponding to datacenter locations that are configured with the virtual extensible local area network.

13. The system of claim 8, wherein the network flow is based on at least one virtual entity selected in the GUI by a user.

14. The system of claim 8, wherein the icons corresponding to physical and virtual entities included in the network flow are displayed in portions of the GUI window corresponding to a datacenter location at which the corresponding physical and virtual entities are deployed.

15. A method for providing a GUI for representing tunnels and stretched networks in a virtual entity pathway virtualization, comprising:
constructing a model of a stretch network having physical and virtual entities and including at least a first datacenter and a second datacenter;
identifying a network flow from a source virtual entity in the stretch network to a destination virtual entity in the stretch network; and
generating a GUI window that includes a graphical representation of the network flow and an arrangement of active icons corresponding to physical and virtual entities included in the network flow from the source virtual entity to the destination virtual entity, wherein the GUI window visually indicates a direction of the network flow from the source virtual entity to the destination virtual entity, including an indication of the network flow passing from a first remote tunnel endpoint (“RTEP”) of the first datacenter to a second RTEP of the second datacenter.

16. The method of claim 1, wherein constructing the model comprises:
obtaining entity data relating to the physical and virtual entities;
categorizing, based on the entity data, the physical and virtual entities by entity type;
assigning the physical and virtual entities to network diagram levels according to their entity type; and
associating the physical and virtual entities based on relationships indicated in the entity data.

17. The method of claim 16, wherein associating the physical and virtual entities includes linking physical and virtual entities that communicate with each other in the network flow using a field in a data table.

18. The method of claim 1, wherein the GUI window visually indicates a virtual extensible local area network of at least a portion of the network flow.

19. The method of claim 18, wherein the virtual extensible local area network is visually indicated by a horizontal bar overlaying only nodes corresponding to datacenter locations that are configured with the virtual extensible local area network.

20. The method of claim 1, wherein the network flow is based on at least one virtual entity selected in the GUI by a user.
